(19) United States
(12) Patent Application Publication
(10) Pub. No.: US 2010/0287568 A1
(43) Pub. Date: Nov. 11, 2010

(54) SYSTEM AND METHOD FOR GENERATION OF INTEGRATED REPORTS FOR PROCESS MANAGEMENT AND COMPLIANCE

(75) Inventors: Arunachalam Sundararaman, Banglalore (IN); Carlos Lopez-Reyna, Louisville, KY (US); Venkatesh Viswanathan, Banglalore (IN)

Correspondence Address: HONEYWELL/HUSCH;Patent Services, 101 Columbia Road, P.O.Box 2245, Morrlstown, NJ, 07962, US

(73) Assignee: Honeywell International Inc., Morristown, NJ (US)

(21) Appl. No.: 12/437,741

(22) Filed: May 8, 2009

(51) Int. Cl. G06F 9/44; H04L 9/32

(52) U.S. Cl. 719/318; 726/20

(57) ABSTRACT

A method and apparatus is provided for generating reports for ensuring process compliance. The method includes the steps of receiving a sign-in event notification for a process, identifying a set of rules for controlling the process based upon a source of the sign-in notification, receiving a sign-out event notification for the process and associating a set of images from the area recording portions of the process with an event report in accordance with the identified rules.

### FIELD OF THE INVENTION

The field of the invention relates to security systems and more particularly to the process requirements of security systems.

### BACKGROUND OF THE INVENTION

Governmental and private organizations have a wide range of security requirements. While physical security can be defined by fences and guard towers, the maintenance of adequate security is also defined by a specific set of processes associated with the physical security. For example, when bank employees perform some tasks, such as removing money from safes or opening Automated Teller Machine, bank policy often require that at least two employees be present. Proof that the proper procedure was followed is essential. Moreover, it is essential to maintain records that two people were in that area with access to the baffles money and where the records are kept for some period of time consistent with good accounting procedures.

Security is equally important in the pharmaceutical industry. According to Drug Enforcement Administration (DEA), it is essential for the pharmaceutical industry to maintain complete records of inventory, investigational use of drugs and supply-chain processes (including tracking of the packages and their contents from distribution center to resale center). Records on the distribution of controlled substances should be kept for a period of 2 years; otherwise the distribution may be considered unlawful. When a drug retailer, like Walgreens, finds drugs missing from the package supplied by a pharma company, it is the pharma company's responsibility to prove to the customer and the government that the drug was actually shipped from the pharma company. Pharma companies can incur heavy losses and have their brand names placed at risk if they fail to provide records as per DEA regulations.

While existing methods of tracking security procedures are reliable, they rely upon the training and experience of employees both for executing the proper procedures and documenting the events. Accordingly, a need exists for better methods of tracking and generating reports on compliance with security procedures.

### BRIEF DESCRIPTION OF THE DRAWINGS

FIG. 1 is a system for generating reports in accordance with an illustrated embodiment of the invention;

FIG. 2 is a report that may be generated by the system of FIG. 1 under a first example; and

FIG. 3 is a report that may be generated by the system of FIG. 1 under a second example.

### DETAILED DESCRIPTION OF AN ILLUSTRATED EMBODIMENT

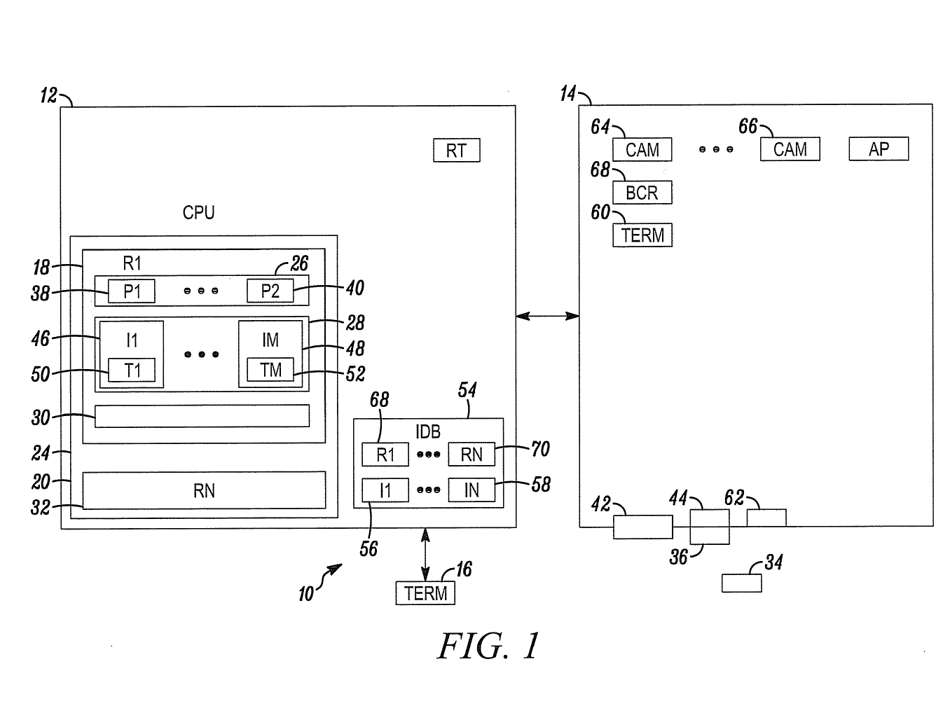

FIG. 1 is a block diagram of a system 10 for generating security reports shown generally in accordance with an illustrated embodiment of the invention. Included within the system 10 may be a host processor 12 that monitors a process area 14.

Also included within the system 10 may be a terminal 16 where a supervisor or other security personnel may create security processes or rules 18, 20 for use within the process area 14. The rules 18, 20 may be embodied as program modules embedded within a computer readable medium (e.g., a magnetically coded media) 24. The rules 18, define the steps of the security process, the order in which they occur, the documentation that is collected into a process report to confirm that the proper steps have been followed and any documentation that is collected in the event of a deviation from the rule 18, 20.

Any particular process could be but need not be confined to an area. In this regard, area typically defines the set of devices participating in the process (e.g., IN/OUT readers in an area). In a supply-chain process, the process steps may not be based on the area but on the set of events generated by the devices, say bar code readers, access readers etc.

The system 10 may be used in any of a number of different security situations requiring different security processes and is not limited to the examples discussed below. In general, the processes are triggered by some type of event. The event that triggers the process could be a person signing in through a card reader, a bar code reader, a biometric reader, a key pad or by the person simply carrying a radio frequency identifier (RFID) device. Alternatively, the process may be triggered by an external system (e.g., the detection of an intrusion by a security system, the detection of a fire by a fire system, an input into a logical access system) or an event generated by an operator action (e.g., through entry of some value into a user interface.

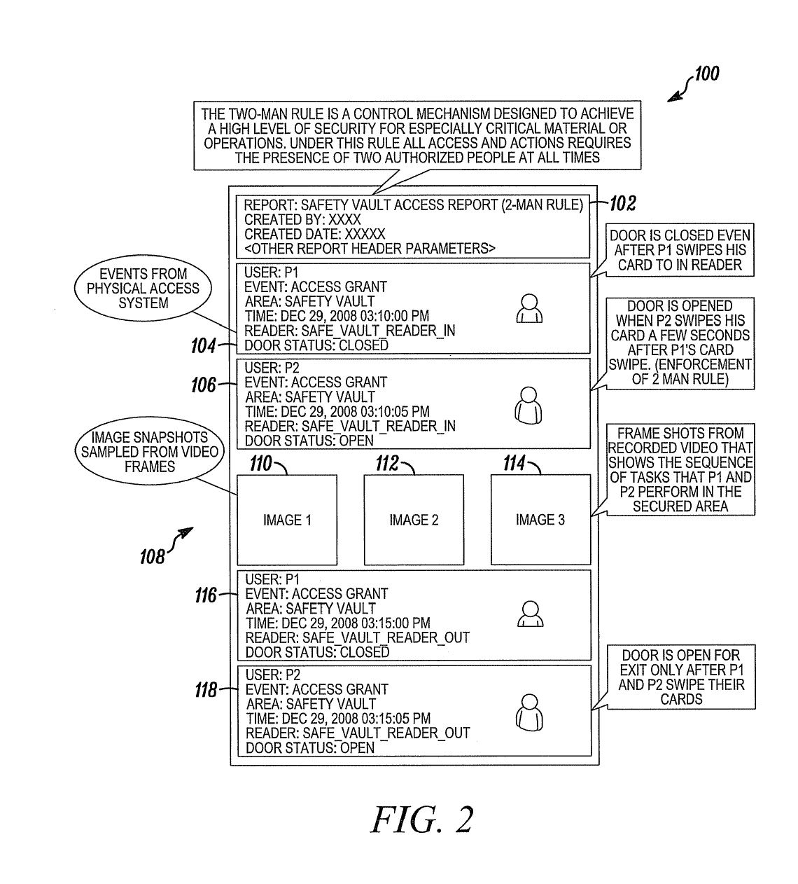

The case of a bank requiring the presence of two persons in order to remove money from a safe or vault may be a simple example of such a process. FIG. 2 depicts a process report 100 that may be generated by the system 10 to track a process where the presence of two persons is required to remove money from a vault area. While FIG. 2 shows a process report 100, FIG. 2 may also be used to more fully depict the steps of the process enforced by the program modules 18, 20.

A first element 102 of the process report 100 may include a header that defines the type of process involved. The header may include an identification of the creator of the process report and the date of creation as well as other header parameters.

A second element 104 and third element 106 depict process steps that may be performed by a person recognition module 26. The process may be initiated by an access request detected through a physical access system. In the case of the bank, the process may begin with a first person P1 swiping (passing) a identity card 34 through a sign-in card reader 36. In this case, the swiping of the identity card 34 causes the host 12 to search for and identify a rule 18, 20 that covers the process area 14. In the case of a bank, the process area 14 has a two-man rule and the host 18 may identify the rule 18 as covering this process area 14.

As shown in FIG. 2, the program module 26 first collects an identifier of the person P1 from the card reader 36. The program module 26 may first verify that the identifier of the person P1 matches an identifier 38 within a list of persons authorized to access the process area 14. As shown in FIG. 2, the module may create a report element 104 that includes the identifier P1 of the user, an indicator that the event is a request for an access grant, an indicator from the location of the card reader 36 that the area is the safety vault, a time of the event, an identifier of the card reader 36 and an indicator that a status of a lock 44 on the door 42 is closed.

If a second person P2 swipes his card 34 through the card reader 36 within some predetermined time period (e.g., 5 seconds), then the program module 26 may proceed to the next step. In this case, the presentation of the card from the second person P2 within the predetermined time period is a requirement under the rule. IF the second user P2 does not present his/her card to the card reader within the time period, then the first user P1 must start over.

Within the next step 106, the program module 26 verifies that an identifier from the card reader 36 matches an identifier 40 of persons authorized to enter the process area 14. If the person P2 is authorized to enter the process area, then the program module 26 may activate a lock 44 on a door 42 of the process area 14. The program module 26 may also create the third report element 106. Within the third report element, the identifier of the person P2 is shown, an indicator that the event is a request for an access grant, an indicator that the location of the card reader 36 is the safety vault, a time, an identifier of the card reader 36 and an indicator that the door status is open.

Once the person recognition module 26 grants access to persons P1, P2, then the recognition module 26 may pass control to an imaging module 28. In this case the imaging module 28 may collect and save within an imaging database 54 a predetermined set of images and, in some cases, audio. Where audio is collected, a voice recognition processor may convert the audio to text that may also be included within a report.

The images and/or audio collected by the imaging module 28 may be defined by a set of imaging parameters 46, 48. One parameter of the imaging parameters 46, 48 may be an identifier of a camera 64, 66 through which the image(s) 56, 58 may be collected. Another parameter may be an event 50, 52 that triggers collection of the respective image. Under one illustrated embodiment, the trigger event 50, 52 may be time, but any other triggering events could be used. For example, one triggering event could be the opening of a particular bin within the safety vault. In this case, the opening of the bin may be detected by a door switch. Alternatively, one of the persons P1, P2 may indicate the opening of the bin through entry of a particular code through a terminal 60.

Upon collection of the predetermined set of images, the image processor 28 may create an image report element 108 including a set of images 110, 112, 114. The set of images 110, 112, 114 of the report element 108 may be single images or may each be a sequence of images either collected at some predetermined data rate (e.g., 30 frames per second) or collected at some predetermined time interval (e.g., once every 10 seconds).

At least one of the triggering events 50, 52 may be the detection of one of the persons P1, P2 swiping his/her card 34 through a sign-out card reader 62. In this case, the imaging module 28 may collect a final image and transfer control of the process 18 to a process completion processor module 30.

The process completion module 30 may parallel the sign-in process. In this case, the process completion module 30 may require that both persons P1, P2 swipe their cards 34 through the sign-out card reader 62 within some predetermined time interval.

As the sign-out process occurs, the process completion processing module 30 may create report elements 118, 120. As the first person P1 swipes his card 34 through the sign-out card reader 62, the processing module 30 may create a report element 116. Included within the report element 116 may be an identifier of the person P1, an identifier of the event as an access grant request to leave the process area, a time, an identifier of the card reader as being inside the process area and an indication that the lock 44 of the door 42 is locked.

If the second person P2 swipes his card 34 through the sign-out card reader 62, the processing module 30 may create a report element 118. Included within the report element 118 may be an identifier of the person P2, an identifier of the event as an access grant request to leave the process area, a time, an identifier of the card reader as being inside the process area and an indication that the lock 44 of the door 42 has now been opened.

The process completion module 30 may also save a copy of the report 100 as an entry 68, 70 within a database 54. The report 100 may be saved with the data content as shown in FIG. 2 or with a set of links (e.g., hyperlinks) to the images 110, 112, 114 within frame sequences 56, 58.

The report is printable and also can be kept in an electronic media like Hard disk/CD/DVD. If the report is kept in HDD/CD/DVD, corresponding images, videos, audios, text can also be in the same media, in which case the hyperlinks in the report can refer to the image/video/audio/text stored in the media.

Where the data content includes a hyperlink, the hyperlink can be to images, video, audio or text related to the process steps. The hyperlink may be in the form of a bar code that describes the images, video, audio or text or a bar code that provides a link to the images, video, audio or text stored in another computer, database or other electronic device.

The system 10 can also be used in the context of manufacturing as a means for insuring the security of a manufacturing process. For example, one application may be for a mantrap on clean room where it is very important to control the flow of air and dust into the secured clean room space.

In this regard, a clean room includes an entrance with an inner and an outer door. In order to preserve the cleanliness of the clean room, the inner and outer doors must never be opened at the same time.

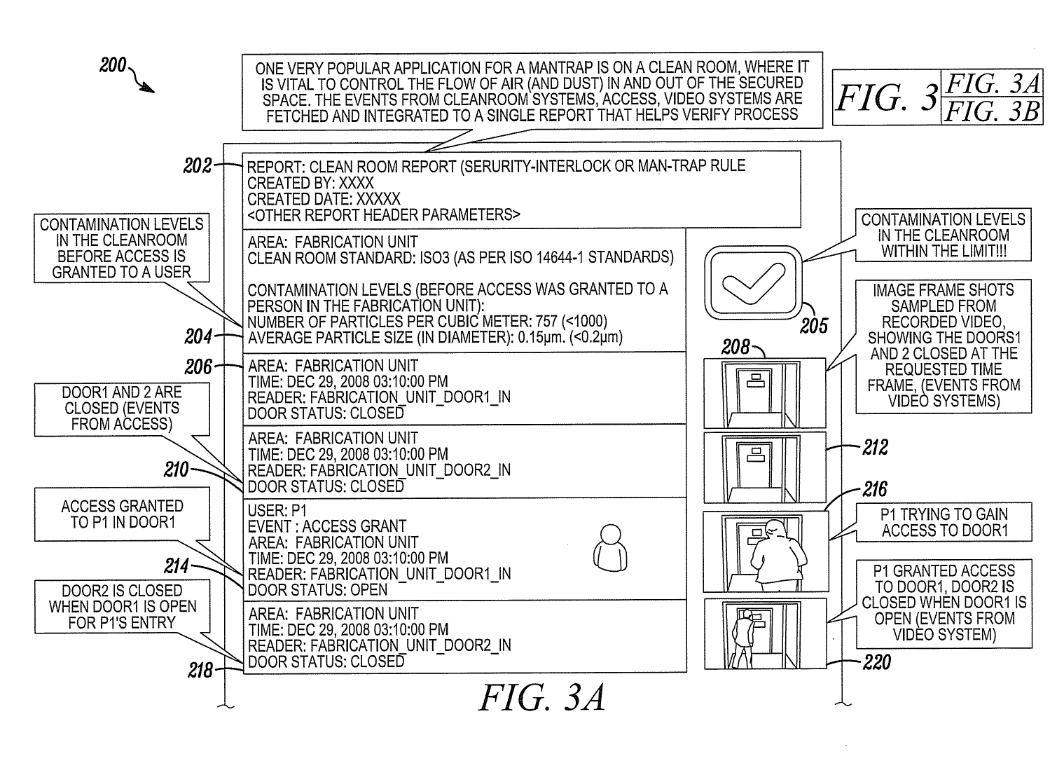

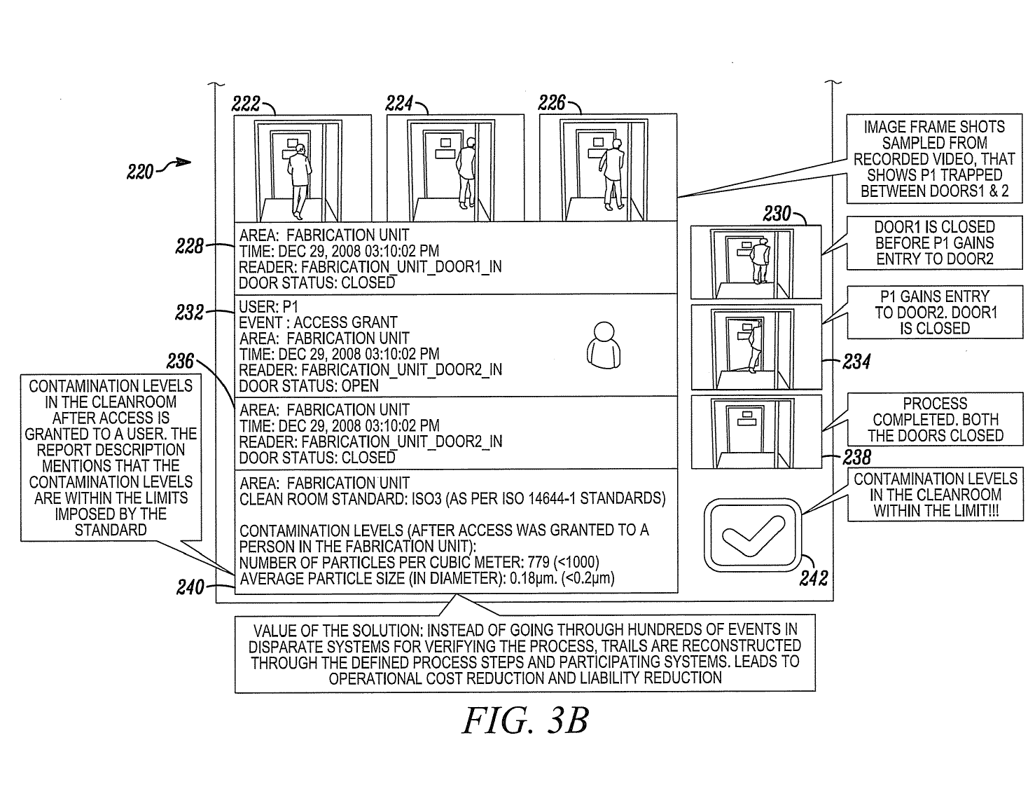

FIG. 3 depicts a report 200 that may be generated by the system 10 used in the context of a clean room. In this case, the modules 26, 28, 30 may operate concurrently and where the person recognition module 26 may (in an idle state) perform a continuous loop sequence where the module 26 may read a particulate meter (not shown) and compare the reading with a threshold level. The modules 26, 28, 30 may also capture images of the inner and outer doors of the clean room.

Upon detecting the swiping of a card 34 through a card reader 36 on the outside the clean room, the system 10 may begin forming the report 200. The modules 26, 28, 30 may create the header 202 in a manner similar to that discussed above. The modules 26, 28, 30 may also create an element 204 listing clean room conditions from a set of most recent readings from the particulate meter. The element 204 may include an identification of the area as being a fabrication unit, a clean room standard that must be met for the process area 14, an actual reading of the particulate meter including the number of particles per cubic meter of air and the average particle size in micrometers.

The report element 204 may also show a graphic 205 indicating whether or not the actual reading meets the required standard. In this case, the presence of the check mark 205 indicates that the actual reading meets the required standard.

The graphic 205 may be provided in any of a number of different formats. For example, the graphic 205 may be an image of a meter where the meter shows the actual reading at the time.

The modules 26, 28, 30 may also create a report element 206, 210 depicting the status 206, 210 of the inner and outer doors along with images 208, 210 previously collected from cameras 64, 66. In each case, the report element 206, 210 indicates the area, the time, a card reader and the status of the doors as closed.

Next the modules 26, 28, 30 may create a report element 214 regarding the detection of a request for entry into the clean room. A first portion 214 of the entry includes an identifier of the person P1 from the card reader 36, an indicator that the event is an access request, an identifier of the area as being the fabrication unit, a time, an identifier of the card reader 36 and an indication that the outside door is unlocked. The modules 26, 28, 30 also collects an image 216 of the outside door and the person P1 outside the outer door.

The modules 26, 28, 30 may create a report element 218 when the modules 26, 28, 30 detects the person P1 opening the outer door. The element 218 contains an identifier of the person P1, a time, an identifier of a card reader 36 between the inner and outer doors and an indication that the inner door is closed. The report element 218 also contains an image 220 of the person P1 passing through the outer door.

The modules 26, 28, 30 may create a report element 220 when the modules 26, 28, 30 detect closing of the outer door. The element 220 contains a set of images 222, 224, 226 including a first image 222 as the outer door is opened, a second image 224 when the outer door closes and a third image shortly thereafter showing that both doors are closed.

The modules 26, 28, 30 may create a report element 228 confirming closure of the outer door. The report element 228 contains an identifier of the area, a time, an identifier of the outer card reader 36 and a status of the outer door as closed. The report element 228 may also includes an image 230 that shows that both doors are closed.

The modules 26, 28, 30 may next create a report element 232 when the modules 26, 28, 30 detect the person P1 swiping his card 34 through the card reader 36 between the two doors. In this case, the report element 232 may include an identifier of the person P1, an indication that the event was an access grant, a time, an identifier of the card reader 36 between the doors and an indication that the inner door is open. The report element 232 may also include an image 234 of the person P1 passing through the inner door.

The modules 26, 28, 30 may create another report element 236 upon detection of closing of the inner door. In this case, the element 236 may include an identifier of the area, a time, an identifier of the card reader 36 and a status of the inner door as closed. The report element 236 may also include an image 238 showing the doors as closed.

Following the report element 236, the modules 26, 28, 30 may generate a final report element 240 following entry of the person P1 into the clean room. The report element 240 may include an identification of the area, the clean room standard, a reading from the particulate meter indicating the number of particles per cubic meter and the average particulate size in micrometers. The modules 26, 28, 30 may also display a visual indication 242 that indicates that the readings from the particulate meter exceed the clean room standard. The final entry confirms that the clean room environment has not been compromised by entry of the person P1.

In another example, the system 10 could be used in the repackaging of drugs or other material requiring a high level of traceability. In this case, a person P1 may retrieve packages from shelves, repackage the material and place the repackaged material on a convey belt that transfers the repackaged materials to a shipment center for distribution to other areas through a carrier. In this case, the process may have two processes activities. In the first activity, the person P1 signs-in to the system 10 for repackaging of each unit of material and sign-out upon completion of the repackaging of the unit.

The person signs-in using a card 34 and card scanner 36 or the system 10 may use a biometric reader to accept sign-in. A set of cameras may record the repackaging process. Upon completing the repackaging of the unit, the person P1 signs-out by scanning the repackaged unit using a bar code reader 68 and placing the repackaged unit onto a conveyor belt. The modules 26, 28, 30 may capture an identifier of the person P1, P2, images and audio from the repackaging process and the bar code and, at the conclusion, generate a corresponding report.

In this case, sign-out of the repackaged unit through the bar code reader becomes a sign-in for the second process. In this case, the second process involves the collection of camera images to track the repackaged unit to a shipment center. At the shipment center, the repackaged unit may again be scanned as a sign-out from the second process.

The system 10 allows the user to create a report template for of integrated reports shown in FIGS. 2 and 3 by retrieving the reports of FIGS. 2 and 3 through the terminal 16 and adjusting the recording parameters by observing the recorded events. The template shows the placeholders for the different types of recorded events (e.g., text, video, audio, bar codes) recorded by different devices participating in the process. As noted above, video events can be stored as a sequence of image snapshots (sampled based on user inputs) or can be hyperlinked or bar code linked to the video stored in the video server. The system 10 may also allow the user to select a stage of the process and choose the video frames of interest from a set of images by sequencing through the sets while viewing the report.

Similarly, the audio details can be retrieved using a link to the audio data stored in the server and edited or incorporated into the report. Alternatively, the audio can be converted to text using speech recognition and embedded in the report using the image snapshots.

Alarms signifying any deviation in the process can be stored in the integrated reports 68, 70. Typical deviations include delay in performing activities in the process beyond some threshold value, an inappropriate (unauthorized) person performing the activity and so on.

Reports generated by the system 10 may be printed at any time. The report need not be necessarily dynamic (i.e. generated immediately after the execution of process step). The report may be generated from the events available in the database at a later time. The events can be from any external system such as logical access system, video system, intrusion system, fire system, and etc. The events may be picked from disparate databases. The process steps would help pick up suitable events and the filter parameters like date/time, and may help in picking up suitable events for generation of reports describing the process.

Users may generate reports at any time. For example, an evidence report that states that a specific drug was actually shipped from a drug distribution center. The user may enter a project order, batch number, date/time that identifies the process followed for shipping a particular drug. The system 10 may use the process steps, pick up events from the database applying the filters specified by the user and generate a report based on the template specified.

Reports may be securely kept within the database. Permissions are provided to valid users and only the authorized users would be able to access the reports

A specific embodiment of method and apparatus for generating reports has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of generating reports comprising:
receiving a sign-in event notification for a process;
identifying a set of rules for controlling the process based upon a source of the sign-in notification;
receiving a sign-out event notification for the process; and
associating a set of images from the area recording portions of the process with an event report in accordance with the identified rules.

2. The method of generating reports as in claim 1 further comprising saving an identifier of a person in the event report.

3. The method of generating reports as in claim 1 wherein the step of associating the images further comprises saving a hyperlink to the images or videos, or audio or text into the report.

4. The method of generating reports as in claim 1 wherein the sign-in or sign-out event notification further comprises one of the group consisting of a card reader, a biometric reader, a key pad that accepts a personal identifier of the person and a bar code reader or events from an external system.

5. The method of generating reports as in claim 1 wherein the sign-in event notification further comprises one of the group consisting of an intrusion alert from a security system or fire alert from a fire detection system or an event generated by an external system or due to a user action in the system.

6. The method of generating reports as in claim 1 further comprising saving one of the group consisting of audio, text, bar code.

7. The method of generating reports as in claim 1 further comprising creating a report template.

8. An apparatus for generating reports comprising:
means for receiving a sign-in event notification for a process from a sign device;
means for identifying a set of rules for controlling the process from the sign-in notification based upon an identifier of the sign-in device;
means for receiving a sign-out event notification from a sign-out device; and
means for associating a set of images that record portions of the event with an event report in accordance with the identified rules.

9. The apparatus for generating reports as in claim 8 further comprising means for saving an identifier of the person in the event report.

10. The apparatus for generating reports as in claim 8 wherein the step of associating the images further comprises means for saving a hyperlink into the report.

11. The apparatus for generating reports as in claim 8 wherein the sign-in or sign-out event notification further comprises one of the group consisting of a card reader, a biometric reader, a key pad that accepts a personal identifier of the person and a bar code reader.

12. The apparatus for generating reports as in claim 8 wherein the sign-in event notification further comprises one of the group consisting of an intrusion alert from a security system or fire alert from a fire detection system or an event generated by an external system or by a user action in the system.

13. The apparatus for generating reports as in claim 8 further comprising means for saving one of the group consisting of audio, text, bar code.

14. The apparatus for generating reports as in claim 8 wherein the identified images further comprise images before or after sign-in and images before or after sign-out.

15. An apparatus for generating reports comprising:
a sign-in event notification for a process;
a set of process modules that identify a set of rules for controlling the process from the sign-in notification based upon an identity of a source of the sign-in notification;
a sign-out event notification for the process; and
an image processor module that associates a set of images from the area recording portions of the process into an event report in accordance with the identified rules.

16. The apparatus for generating reports as in claim 15 further comprising an identification processor that saves an identifier of the person in the event report.

17. The apparatus for generating reports as in claim 15 wherein the association of the images further comprises a hyperlink.

18. The apparatus for generating reports as in claim 15 wherein the sign-in or sign-out event notification further comprises the use of one of the group consisting of a card reader, a biometric reader, a key pad that accepts a personal identifier of the person and a bar code reader.

19. The apparatus for generating reports as in claim 15 further comprising a database that saves data from one of the group consisting of audio, text, bar code.

20. The apparatus for generating reports as in claim 15 wherein the sign-in event notification further comprises one of the group consisting of an intrusion alert from a security system or fire alert from a fire detection system or an event generated by an external system or by a user action in the system.
